(19) United States
(12) Patent Application Publication
(10) Pub. No.: US 2008/0123546 A1
(43) Pub. Date: May 29, 2008

(54) IP TELEPHONE

(75) Inventors: Shinsuke ISONO, Koriyama-shi (JP); Fumio Urayama, Koriyama-shi (JP)

Correspondence Address: FOLEY AND LARDNER LLP;SUITE 500, 3000 K STREET NW, WASHINGTON, DC, 20007, US

(73) Assignee: HITACHI COMMUNICATION TECHNOLOGIES, LTD.

(21) Appl. No.: 11/843,518

(22) Filed: Aug. 22, 2007

(30) Foreign Application Priority Data
Nov. 27, 2006 (JP) 2006-319009

(51) Int. Cl. H04L 12/56

(52) U.S. Cl. 370/252; 370/352

(57) ABSTRACT

An object is to provide an IP telephone enabling to grasp the traffic volume on the network under condition except when during communications.

The IP telephone 2 or 2A having a LAN port for connecting to a LAN network 5 and for transmitting and receiving packets through the LAN port, the IP telephone comprises, traffic volume measuring section 17 for always measuring the traffic volume of packets through the LAN port; circuit quality level generating section 22 for generating the circuit quality level corresponding to the traffic volume based on the measured result of the traffic volume measured by the traffic volume measuring section; and display control section 16 for displaying the circuit quality level corresponding to the traffic volume generated by the circuit quality level generating section on the screen of the monitor display section 13.

### CROSS-REFERENCES TO RELATED APPLICATION

This application claims priority benefit under 35 U.S.C. .sctn. 119 of Japanese Patent Application No. 2006-319009, filed on Nov. 27, 2006, the entirety of which is incorporated herein by reference.

### BACKGROUND OF THE INVENTION

1. Field of the Invention

The present invention relates to an IP telephone, which is accommodated for connection to an IP telephone exchange to be connected to a LAN network, for example, and which achieves communications with a party terminal with packet communication.

2. Description of the Related Art

Generally, an Internet protocol telephone (hereinafter referred to an IP telephone) utilizing the voice over Internet protocol (hereinafter referred to VoIP) achieves communications with a party terminal by changing voice to IP packets; however, the voice quality can possibly deteriorate if the packet delay, jitter, packet loss or the like occurs.

Therefore, it is necessary to ensure the band width on the LAN network in order to avoid such deterioration of the voice quality. However, when operating on the network such as the Internet, the packet may reach with a delay due to processing delay of a network equipment such as switch, the jitter may occur, or the packet loss of the voice packet may occur due to the failure of the network equipment.

However, when the user of the IP telephone operates the network equipment under such conditions without knowing the information relating to the traffic, can possibly misconstrue the failure of the IP telephone, because the user can not distinguish whether the failure is of this network equipment itself or of the traffic problem on the network.

Therefore, in order to protect against such problem, a well-known IP telephone, for example, the Japanese Patent Laid open Application; No. 2002-232475 (document 1), monitors the reach of the packet during the communications, measures the packet delay, jitter, data loss or the like exerting the influence upon the voice quality, and displays the measured result on a monitor display of the IP telephone.

The IP telephone described in the document 1 monitors the reach of the packet during the communications, measures the packet delay, jitter, data loss or the like, and displays the measured result on the monitor display, so that the user can recognize the deteriorate of the communications quality due to the influence from the traffic on the network based on the contents in the screen on the display, and avoid to misconstrue the failure of the IP telephone.

### BRIEF SUMMARIZING OF THE INVENTION

Though the IP telephone described in the document 1 monitors the reach of the packet during the communications, measures the packet delay, jitter, data loss or the like, and displays the measured result on the monitor display, it measures the packet delay, jitter, data loss or the like, only during the communications. As the result of this, it is not able to grasp the traffic on the network except when during communications; for example, under the condition of waiting an incoming call.

The present invention intends to solve the problem described above; its object is to provide an IP telephone that the user can grasp the traffic on the network except when during communications.

To achieve the object described above, an IP telephone according to the present invention has a LAN port connecting to the LAN network, and transmits and receives packets through the LAN port, wherein the IP telephone comprises traffic measuring means for always measuring the traffic volume of the packets through the LAN port, circuit quality level generating means for generating the circuit quality level corresponding to the traffic volume based on the measured result of traffic volume through the traffic measuring means, and display control means for displaying the circuit quality level corresponding to the traffic volume generated by the circuit quality level generating means.

Therefore, the IP telephone according to the present invention always measuring the traffic volume of the packets through the LAN port, generating the circuit quality level corresponding to the traffic volume based on the measured result of traffic volume, and displaying the circuit quality level corresponding to the traffic volume, so that the user can grasp the circuit quality level corresponding to the traffic volume in real time under condition except when during communications as well as during communications. As a result, the user can distinguish the deterioration of the communications quality is whether by depending upon the network or by the failure of equipment, so that it is able to shorten the spending time from the trouble occurring to the improvement of the communications quality.

The IP telephone according to the present invention further comprises measured result notifying means for notifying the measured result of traffic measuring means to the IP telephone exchange by which this IP telephone is accommodated for connection.

Therefore, the IP telephone according to the present invention notifies the measured result of traffic measuring means to the IP telephone exchange by which this IP telephone is accommodated for connection, so that the IP telephone exchange can intensively grasp the traffic volume under condition except when during communications as well as during communications.

The IP telephone according to the present invention further comprises packet loss measuring means for measuring the number of packet losses through the LAN port; the circuit quality level generating means generates the circuit quality level corresponding to the number of packet losses based on the measured result of the packet loss measuring means, and displays the generated circuit quality level corresponding to the number of packet losses through the display control means.

Therefore, the IP telephone according to the present invention measures the number of packet losses through the LAN port, generates the circuit quality level corresponding to the number of packet losses based on the measured result, and displays the generated circuit quality level corresponding to the number of packet losses, so that the user can grasp the circuit quality level corresponding to the traffic volume under condition except when during communications as well as during communications, of course, and also grasp the circuit quality level corresponding to the number of packet losses in real time. As a result, the user can grasp the deterioration of the communications quality involved in increasing the number of packet losses, so that it is able to shorten the spending time from the trouble occurring to the improvement of the communications quality.

The IP telephone according to the present invention further comprises measured result notifying means for notifying the measured result of the packet loss measuring means to the IP telephone exchange by which this IP telephone is accommodated for connection.

Therefore, the IP telephone according to the present invention notifies the measured result of the packet loss measuring means to the IP telephone exchange by which this IP telephone is accommodated for connection, so that the IP telephone exchange can intensively grasp the number of packet losses of each IP telephone as well as the traffic volume of each IP telephone.

In the IP telephone according to the present invention, further, the IP telephone exchange comprises measured result receiving means for receiving the measured result of the traffic volume measuring means through the measured result notifying means of each IP telephone accommodated for connection by the IP telephone exchange, measured result summarizing means for summarizing the measured result of each IP telephone received by the measured result receiving means, and display control means of exchange side for displaying the measured result of each IP telephone summarized by the measured result summarizing means.

According to the IP telephone of the present invention, the IP telephone exchange receives the measured result of the traffic volume measuring means through the measured result notifying means of each IP telephone, summarizes this received measured result of the each IP telephone, and displays this summarized measured result of the each IP telephone; so that the maintenance person managing the network of the exchange side can intensively grasp the traffic volume of each IP telephone on the network by visually checking the contents of the screen on the display, and specify the cause of trouble due to the traffic volume. As a result, it is able to widely shorten the time required from the trouble occurring to the improvement of the communications quality.

Further, according to the IP telephone of the present invention, the IP telephone exchange manages each IP telephone accommodated for connection in a unit of group, summarizes the measured result of each IP telephone in a unit of group through the measured result summarizing means, and displays the measured result in a unit of group summarized by the measured result summarizing means through the display control means of the exchange side.

Therefore, in the IP telephone according to the present invention, the IP telephone exchange manages each IP telephone accommodated for connection in a unit of group, summarizes the measured result of each IP telephone in a unit of group through the measured result summarizing means, and displays the measured result in a unit of group summarized by the measured result summarizing means through the display control means of the exchange side; so that the maintenance person managing the network of the exchange side can intensively grasp the traffic volume of each IP telephone in a unit of group on the network by visually checking the contents of the screen on the display, and specify the cause of trouble due to the traffic volume. As a result, it is able to widely shorten the time required from the trouble occurring to the improvement of the communications quality.

In the IP telephone according to the present invention, the IP telephone exchange further comprises measured result receiving means for receiving the measured result of the packet loss measuring means through the measured result notifying means of each IP telephone accommodated for connection, measured result summarizing means for summarizing the measured result of each IP telephone received by the measured result receiving means, and display control means of the exchange side for displaying the measured result of each IP telephone summarized by the measured result summarizing means.

Therefore, in the IP telephone according to the present invention, the IP telephone exchange receives the measured result of the packet loss measuring means, summarizes the received measured result, and displays the summarized measured result; so that the maintenance person managing the network of the exchange side can intensively grasp the number of packet losses of each IP telephone on the network by visually checking the contents of the screen on the display, and specify the cause of trouble involved in increasing the number of packet losses. As a result, it is able to widely shorten the time required from the trouble occurring to the improvement of the communications quality.

The IP telephone of the present invention configured as described above, always measures the traffic volume of the packets through the LAN port, generates the circuit quality level corresponding to the traffic volume based on the measured result of this traffic volume, and displays the generated circuit quality level corresponding to the traffic volume, so that the user can grasp the circuit quality level corresponding to the traffic volume on the network in real time under the condition not only during communications but also except when during communications. As a result, the user can distinguish the deterioration of the communications quality is whether by depending upon the network or by failure of the equipment, so that it is able to shorten the spending time from the trouble occurring to the improvement of the communications quality.

### BRIEF DESCRIPTION OF THE DRAWINGS

FIG. 1 is a block diagram showing a schematic configuration of an inside of an IP telephone system of an embodiment relating to an IP telephone of the present invention;

FIG. 2 is a block diagram showing a schematic configuration of an inside of an IP telephone relating to the present embodiment;

FIG. 3 is an illustrative view easily showing table contents of a measured result memory section of an IP telephone relating to the present embodiment;

FIG. 4 is an illustrative view easily showing table contents of a circuit quality level management section of an IP telephone relating to the present embodiment;

FIG. 5 is an illustrative view easily showing display contents of circuit quality levels of an IP telephone relating to the present embodiment, where (A) are circuit quality levels corresponding to traffic volume, (B) are circuit quality levels corresponding to packet losses, and (C) is a circuit quality level corresponding to a Dos attack;

FIG. 6 is an illustrative view easily showing display contents of circuit quality levels of an IP telephone relating to the present embodiment;

FIG. 7 is a block diagram showing a schematic configuration of an inside of an IP telephone exchange relating to the present embodiment;

FIG. 8 is an illustrative view easily showing table contents of a measured result memory section of an IP telephone exchange relating to the present embodiment, where (A) is a unit of IP telephone and (B) is a unit of group;

FIG. 9 is an illustrative view easily showing table contents of a circuit quality level management section of an exchange side relating to the present embodiment;

FIG. 10 is a flow chart showing processing operation of a circuit quality level generating section relating to generating process of circuit quality level corresponding to traffic volume of an IP telephone relating to the present embodiment;

FIG. 11 is a flow chart showing processing operation of a circuit quality level generating section relating to generating process of circuit quality level corresponding to the number of packet losses of an IP telephone relating to the present embodiment; and

FIG. 12 is a flow chart showing processing operation of a measured result summarizing section relating to traffic summarizing process in a unit of group of an IP telephone exchange relating to the present embodiment.

### DETAILED DESCRIPTION OF THE PREFERRED EMBODIMENTS

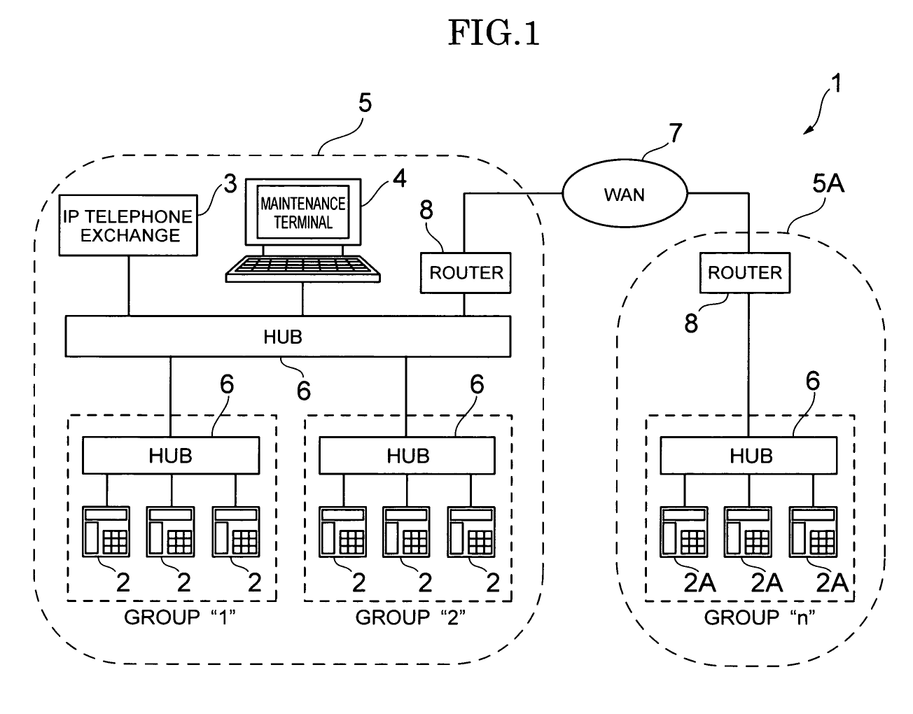

Hereinafter, an IP telephone relating to an embodiment according to the present invention will be described in conjunction with the accompanying drawings. FIG. 1 is a block diagram showing a schematic configuration of an inside of an IP telephone system of an embodiment of the present embodiment.

The IP telephone system 1 shown in FIG. 1 includes a plurality of IP telephones 2 (or 2A) configured in a unit of group, an IP telephone exchange 3 switching the plurality of IP telephones 2 (or 2A) in a unit of group, a maintenance terminal 4 maintaining this IP telephone exchange 3, HUBs 6 for connecting the IP telephones 2 in a unit of group, IP telephone exchange 3, and maintenance terminal 4 to a LAN network 5, a router 8 for communicating with IP telephones 2A within other LAN network 5A via a wide area network (hereinafter referred to a WAN) 7; wherein the IP telephone exchange 3 establishes communications with packet communication between the IP telephones 2 within the same LAN network 5 each other, and also establishes communications with packet communication between the IP telephone 2 within the self-LAN network 5 and other IP telephone 2A via the router 8 and WAN 7.

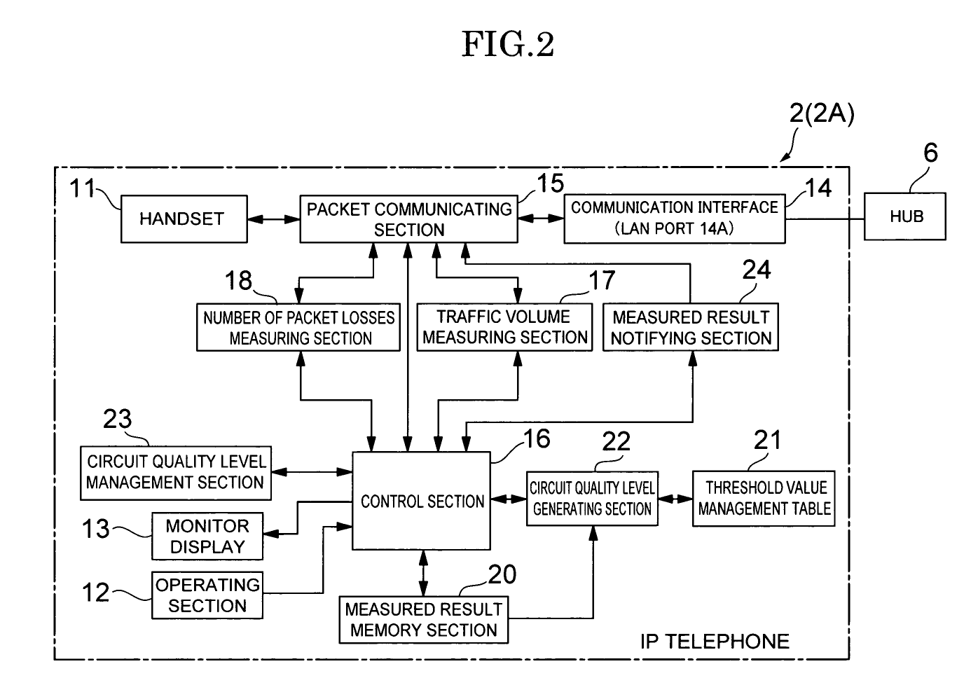

FIG. 2 is a block diagram showing a schematic configuration of the inside of the IP telephone 2 (or 2A).

The IP telephones 2 (or 2A) shown in FIG. 2 comprises a handset 11, an operating section 12 for inputting various commands, a monitor display section 13 for displaying various information, a communication interface 14 including a LAN port 14A connected to the HUB 6, a packet communication section 15 for transmitting/receiving packets through this LAN port 14A, a control section 16 for entirely controlling this IP telephone exchange 3; wherein the packet communication section 15 establishes communications by performing voice packet communications to an opposite terminal through the IP telephone exchange 3.

The IP telephone 2 (or 2A) shown in FIG. 2 further comprises a traffic volume measuring section 17 for always measuring the traffic volume of packets through the LAN port 14A, a packet loss measuring section 18 for measuring the number of packet losses through the LAN port 14A, a measured result memory section 20 for sequentially storing the measured result from the traffic volume measuring section 17 (traffic volume) and the measured result of the number of packet losses from the packet loss measuring section 18 (the number of packet losses), a threshold value management table 21 for managing a predetermined threshold value (traffic volume threshold value, packet loss threshold value, and Dos attack threshold value) in order to generate a circuit quality level that will be described later, a circuit quality level generating section 22 for generating the circuit quality level corresponding to the traffic volume, circuit quality level corresponding to the number of packet losses, and circuit quality level corresponding to the Dos attack, based on the traffic volume threshold value, packet loss threshold value, and Dos attack threshold value stored in this threshold value management table 21, a circuit quality level management section 23 for storing and managing the circuit quality level corresponding to the traffic volume, circuit quality level corresponding to the number of packet losses, and circuit quality level corresponding to the Dos attack generated by this circuit quality level generating section 22, a measured result notifying section 24 for notifying the measured results such as the circuit quality level corresponding to the traffic volume, circuit quality level corresponding to the number of packet losses stored in the measured result memory section 20 to the IP telephone exchange 3; wherein the control section 16 displays the circuit quality level corresponding to the traffic volume, circuit quality level corresponding to the number of packet losses, and circuit quality level corresponding to the Dos attack stored in and managed by the circuit quality level management section 23 on the screen of the monitor display 13.

The control section 16 always measures the traffic volume of packets during 1 second through the traffic measuring section 17 under the condition not only during communications but also except when during communications, and sequentially stores the traffic volume of the measured result with the measuring date and time into the measured result memory section 20.

The control section 16 measures the number of packet losses of the received packets during 10 seconds, and sequentially stores the number of packet losses of the measured result with the measuring date and time into the measured result memory section 20.

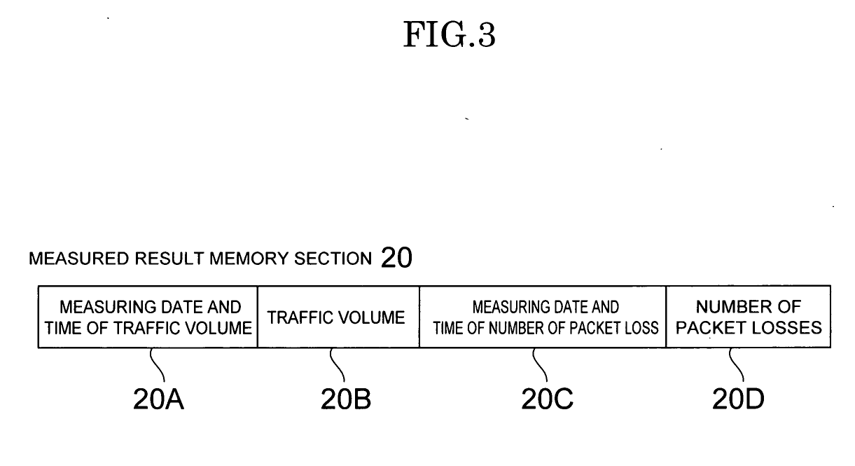

FIG. 3 is an illustrative view easily showing table contents of the measured result memory section 20.

The measured result memory section 20 shown in FIG. 3 manages the traffic volume measuring date and time 20A measured by the traffic volume measuring section 17, the traffic volume 20B during 1 second as its measured result, the packet loss measuring date and time 20C measured by the number of packet losses measuring section 18, and the number of packet losses 20D during 10 seconds as its measured result.

The measured result notifying section 24 notifies the IP telephone exchange 3, at predetermined timing, the measured results consisting of: the traffic information including the traffic volume 20B, measuring date and time 20A, and IP telephone identification information of the IP telephone 2 (or 2A) stored in the measured result memory section 20; the packet loss information including the number of packet losses 20D, measuring date and time 20C, and IP telephone identification information stored in the measured result memory section 20; and the received packet information including the IP telephone identification information. In addition, the predetermined timing is 5 minutes, for example, the measured result notifying section 24 notifies the traffic information, packet loss information, and received packet information relating to the IP telephone 2 during 5 minutes to the IP telephone exchange 3.

The threshold value management table 21 manages a plurality of traffic volume threshold values for generating the circuit quality level corresponding to the traffic volume, a plurality of packet loss threshold values for generating the circuit quality level corresponding to the number of packet losses, and Dos attack threshold values (2000 packets) for generating circuit quality level corresponding to the Dos attack. The traffic volume threshold values consist of a first traffic volume threshold value (499 packets), a second traffic volume threshold value (500 to 999 packets), and a third traffic volume threshold value (1000 to 1499 packets); the packet loss threshold values consist of a fist packet loss threshold value (9 packets), a second packet loss threshold value (10 to 49 packets), and a third packet loss threshold value (50 to 99 packets).

The circuit quality level generating section 22, based on the traffic volume threshold values stored in the threshold value management table 21, generates a circuit quality level that is a traffic level “0” indicating an optimum circuit quality condition, when the number of packets during 1 second corresponding the current traffic volume is less than or equal to the first traffic volume threshold value (499 packets); generates a circuit quality level that is a traffic level “1” indicating a circuit quality condition that is good but not optimum, when the number of packets during 1 second is less than or equal to the second traffic volume threshold value (500 to 999 packets); generates a circuit quality level that is a traffic level “2” indicating a circuit quality condition that communication quality is deterioration but able to communicate, when the number of packets during 1 second is less than or equal to the third traffic volume threshold value (1000 to 1499 packets); or generates a circuit quality level that is a traffic level “3” indicating a circuit quality condition that interferes the communications, when the number of packets during 1 second is greater than the third traffic volume threshold value.

And, the circuit quality level generating section 22, based on the packet loss threshold values stored in the threshold value management table 21, generates a circuit quality level that is a loss level “0” indicating an optimum circuit quality condition, when the number of packet losses during 10 seconds is less than or equal to the fist packet loss threshold value (9 packets); generates a circuit quality level that is a loss level “1” indicating a good but not optimum circuit quality condition, when the number of packet losses during 10 seconds is less than or equal to the second packet loss threshold value (10 to 49 packets); generates a circuit quality level that is a loss level “2” indicating a circuit quality condition that communication quality is deterioration but able to communicate, when the number of packet losses during 10 seconds is less than or equal to the third packet loss threshold value (50 to 99 packets); or generates a circuit quality level that is a loss level “3” indicating a circuit quality condition that interferes the communications, when the number of packet losses during 10 seconds is greater than the third packet loss threshold value.

And, the circuit quality level generating section 22, based on the Dos attack threshold values stored in the threshold value management table 21, generates a circuit quality level that indicates being subjected to the Dos attack, when the number of currently receiving packets during 1 second (traffic volume) is greater than or equal to the Dos attack threshold value (2000 packets). In addition, the Dos attack threshold value is set to a value that is extensively greater than the possible number of packets which an IP telephone receives during 1 second in the system utilized thereby.

The control section 16 stores the circuit quality level generated by the circuit quality level generating section 22 into the circuit quality level management section 23, and displays the circuit quality level stored in this circuit quality level management section 23 on the screen of the monitor display 13.

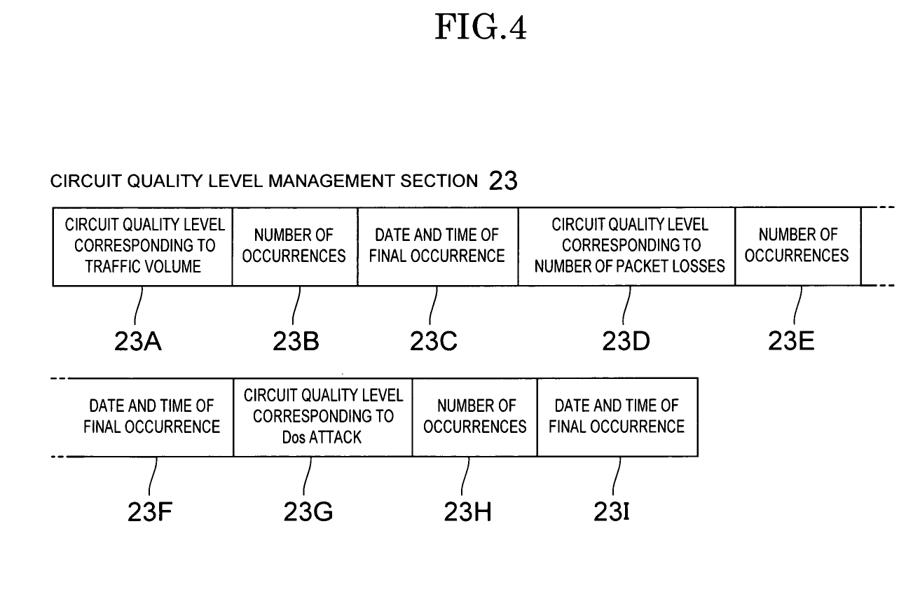

FIG. 4 is an illustrative view easily showing table contents of the circuit quality level management section 23.

The circuit quality level management section 23 manages the number of occurrences 23B and the final occurrence date and time 23C at each traffic level 23A of the circuit quality level corresponding to traffic volume, manages the number of occurrences 23E and the final occurrence date and time 23F at each loss level 23D corresponding to the number of packet losses, and manages the number of occurrences 23H and the final occurrence date and time 23I at each circuit quality level 23G of the circuit quality level corresponding to the Dos attack.

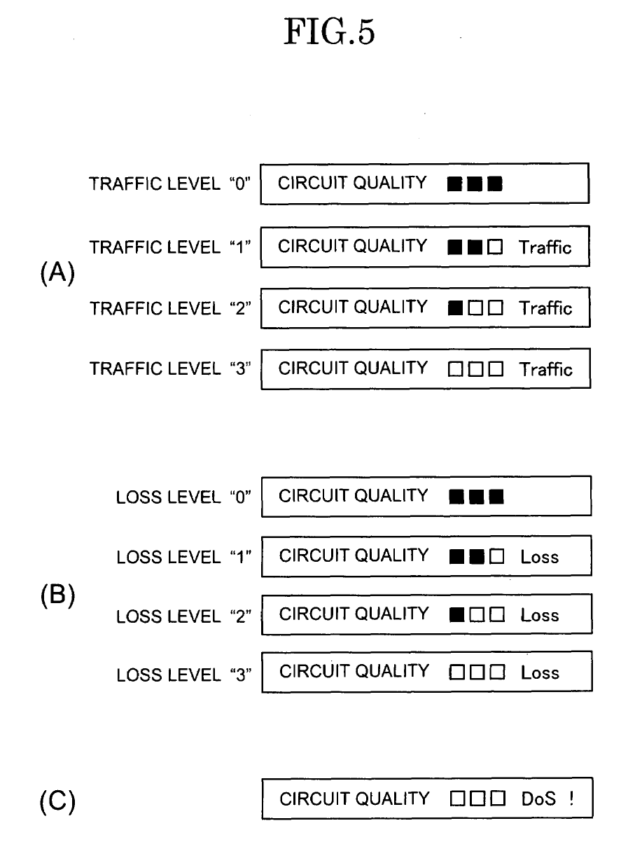

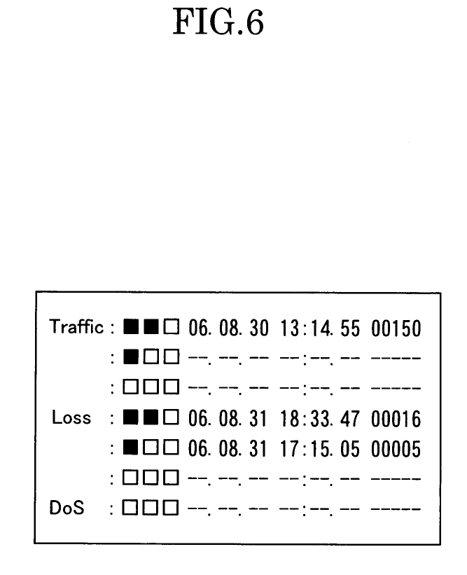

Further, the control section 16, in response to a predetermined operation, as shown in FIGS. 5 and 6, can statistically display circuit quality levels corresponding to the traffic volume, circuit quality levels corresponding to the number of packet losses, and circuit quality level corresponding to the Dos attack at each level on the screen of the monitor display 13.

FIG. 5A equates to a screen contents of the circuit quality levels corresponding to traffic volume, four kinds of screens are totally displayed at each traffic level.

FIG. 5B equates to a screen contents of the circuit quality levels corresponding to the number of packet losses, four kinds of screens are totally displayed at each packet loss.

FIG. 5C equates to a screen contents of the circuit quality levels corresponding to the Dos attack.

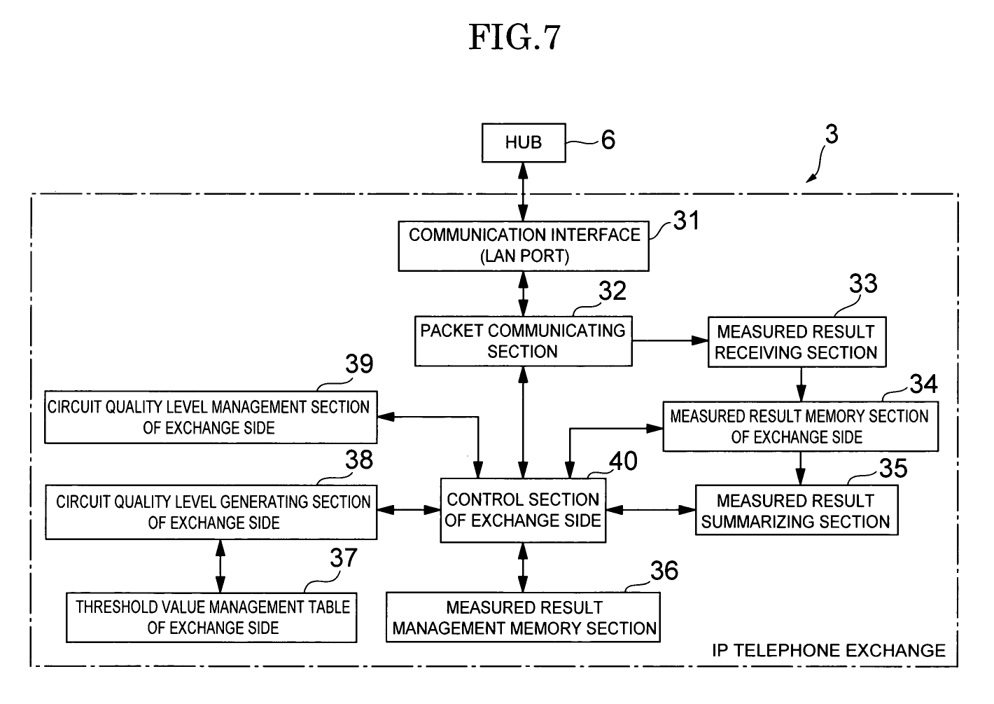

FIG. 7 is a block diagram showing a schematic configuration of an inside of the IP telephone exchange 3.

The IP telephone exchange 3 shown in FIG. 7 comprises a communication interface (LAN port) 31 for performing interface in order to transmit and receive packets of call connection for controlling the call connection between the IP telephones 2 and 2A each other, a packet communication section 32 for transmitting and receiving packets through this LAN port 31, and a control section 40 of the exchange side for performing call control between the IP telephones 2 and 2A and management of entire control of the exchange.

The IP telephone exchange 3 further comprises a measured result receiving section 33 for receiving measured results such as the traffic information and packet loss information measured by the IP telephone 2 or 2A via the LAN port 31 and packet communication section 32, in order to summarize and statistically process them; a measured result memory section 34 of the exchange side for sequentially storing the measured results such as the traffic information and packet loss information of each IP telephone 2 received by this measured result receiving section 33; a measured result summarizing section 35 for summarizing the measured result of each IP telephone 2, which is stored in the measured result memory section 34 of the exchange side, in a unit of IP telephone and in a unit of group; a measured result management memory section 36 for managing the measured results in a unit of IP telephone and in a unit of group summarized by this measured result summarizing section 35; a threshold value management table 37 of the exchange side for managing a predetermined threshold values (traffic volume threshold value, packet loss threshold value, and Dos attack threshold value) in order to generate the circuit quality levels; a circuit quality level generating section 38 of the exchange side for generating the circuit quality level corresponding to the traffic volume, circuit quality level corresponding to the number of packet losses, and circuit quality level corresponding to the Dos attack in a unit of IP telephone, and the circuit quality level corresponding to the traffic volume in a unit of group, based on the traffic volume threshold value, packet loss threshold value, and Dos attack threshold value stored in this threshold value management table 37 of the exchange side; a circuit quality level management section 39 of the exchange side for storing and managing the circuit quality level corresponding to the traffic volume, circuit quality level corresponding to the number of packet losses, and circuit quality level corresponding to the Dos attack generated by this circuit quality level generating section 38 of the exchange side; and a control section 40 of the exchange side for entirely controlling the IP telephone exchange 3, wherein the control section 40 of the exchange side monitor-displays each circuit quality level in a unit of group and in a unit of IP telephone managed by the circuit quality level management section 39 of the exchange side on the display screen of the maintenance terminal 4.

The measured result summarizing section 35, based on the traffic information and packet loss information of each IP telephone 2, which are stored in the measured result memory section 34 of the exchange side, summarizes the traffic volume and the number of packet losses in a unit of IP telephone, divides the summarized result of the traffic volume of all IP telephones 2 or 2A in a unit of group, i.e., the total traffic volume of all IP telephones at the same date and time within the same group by the number of IP telephones 2 or 2A of the same group, and summarizes the traffic volume of this divided result as the average traffic volume in a unit of group.

The control section 40 of the exchange side manages the traffic volume and the number of packet losses in a unit of IP telephone and the traffic volume in a unit of group, which are summarized through the measured result summarizing section 35.

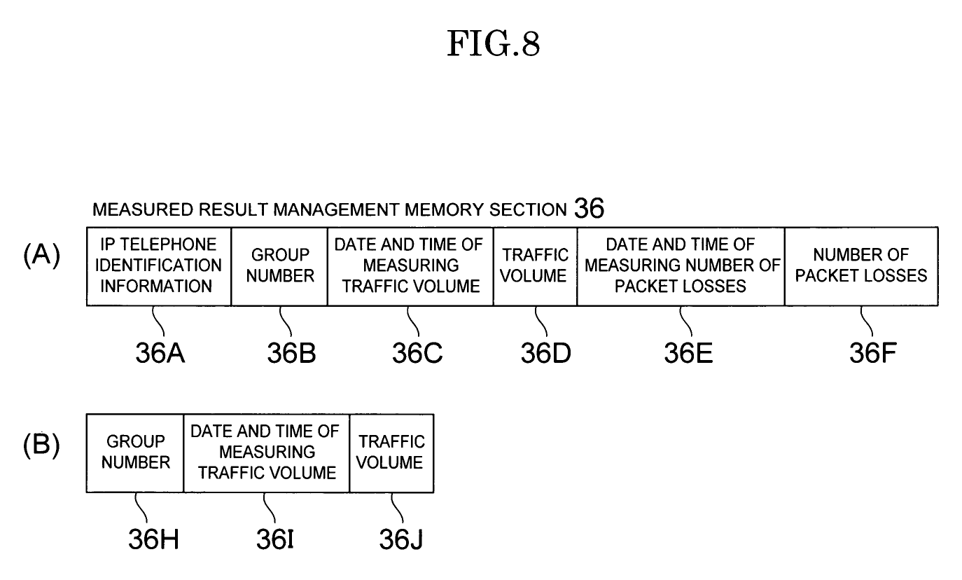

FIG. 8 is an illustrative view easily showing table contents of the measured result memory section 36.

The measured result memory section 36 shown in FIG. 8 manages the measured result in a unit of IP telephone and the measured result in a unit of group. As shown in FIG. 8A, the measured result memory section 36 managing the measured result in a unit of IP telephone, manages an IP telephone identification information 36A for identifying the IP telephones 2 or 2A, a group number 36B for identifying the group to which this IP telephone 2 is belonged, the measuring date and time 36C of the traffic volume, the traffic volume 36D during 1 second as the measured result, the measuring date and time 36E of the number of packet losses, and the number of packet losses 36F during 10 seconds as the measured result.

As shown in FIG. 8B, the measured result memory section 36 managing the measured result in a unit of group, manages the group number 36H, the measuring date and time 36I of traffic volume within the group, and the average traffic volume 36J within the group.

The circuit quality level generating section 38 of the exchange side generates the circuit quality level corresponding to the traffic volume in a unit of IP telephone based on the traffic volume 36D in a unit of IP telephone stored in the measured result memory section 36 and the traffic volume threshold value stored in the threshold value management table 37 of the exchange side; and generates the circuit quality level corresponding to the traffic volume in a unit of group based on the average traffic volume 36J in a unit of group stored in the measured result management memory section 36 and the traffic volume threshold value stored in the threshold value management table 37 of the exchange side.

Further, the circuit quality level generating section 38 of the exchange side generates the circuit quality level corresponding to the number of packet losses in a unit of IP telephone based on the number of packet losses 36F in a unit of IP telephone stored in the measured result management memory section 36 and the packet loss threshold value stored in the threshold value management table 37 of the exchange side.

Further, the circuit quality level generating section 38 of the exchange side generates the circuit quality level corresponding to the Dos attack in a unit of IP telephone based on the number of received packets (traffic volume) 36D in a unit of IP telephone stored in the measured result memory section 36 and the Dos attack threshold value stored in the threshold value management table 37 of the exchange side.

Further, the control section 40 of the exchange side stores and manages the circuit quality level corresponding to the traffic volume, circuit quality level corresponding to the number of packet losses, and circuit quality level corresponding to the Dos attack in a unit of IP telephone generated by the circuit quality level generating section 38 of the exchange side into the circuit quality level management section 39 of the exchange side; and stores and manages the circuit quality level corresponding to the traffic volume in a unit of group generated by the circuit quality level generating section 38 of the exchange side into the circuit quality level management section 39 of the exchange side.

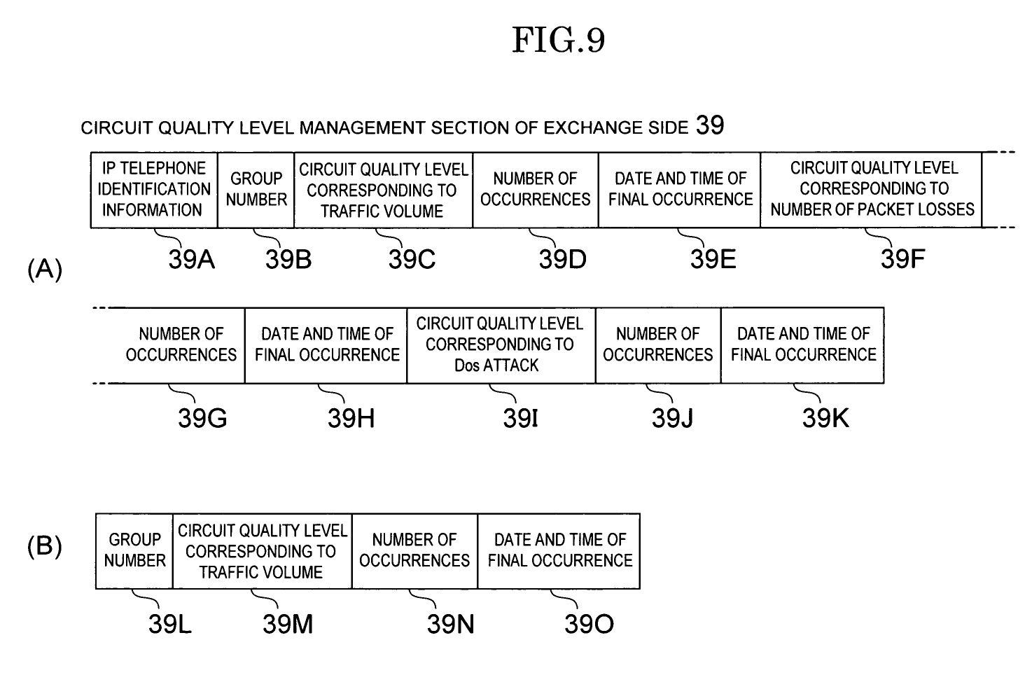

FIG. 9 is an illustrative view easily showing table contents of the circuit quality level management section 39 of the exchange side.

The circuit quality level management section 39 shown in FIG. 9 of the exchange side manages the circuit quality level in a unit of IP telephone and the circuit quality level in a unit of group. As shown in FIG. 9A, the table managing the circuit quality level in a unit of IP telephone manages the IP telephone identification information 39A for identifying the IP telephones 2 or 2A, the group number 39B for identifying the group to which the same IP telephone 2 or 2A is belonged, the traffic level 39C of the circuit quality level of the same IP telephones 2 or 2A, the number of occurrences 39D at each traffic level, the final occurrence date and time 39E, the loss level 39F of the circuit quality level corresponding to the number of packet losses of the same IP telephones 2 or 2A, the number of occurrences 39G at each loss level, the final occurrence date and time 39H, the circuit quality level 391 corresponding to the Dos attack of the same IP telephones 2 or 2A, the number of occurrences 39J, and the final occurrence date and time 39K.

The table managing the circuit quality level in a unit of group, as shown in FIG. 9B, manages the group number 39L, the traffic level 39M of the circuit quality level corresponding to the traffic volume relating to the same group, the number of occurrences 39N at each traffic level, and the final occurrence date and time 39O.

The control section 40 of the exchange side, in response to a predetermined operation from the maintenance terminal 4, displays the circuit quality level corresponding to the traffic volume, circuit quality level corresponding to the number of packet losses, and circuit quality level corresponding to the Dos attack in a unit of IP telephone, which are stored in the circuit quality level management section 39 of the exchange side, on the screen of the monitor display of the maintenance terminal 4.

Further, the control section 40 of the exchange side, in response to a predetermined operation from the maintenance terminal 4, displays the circuit quality level corresponding to the traffic volume in a unit of group stored in the circuit quality level management section 39 of the exchange side on the screen of the monitor display of the maintenance terminal 4.

Further, the control section 40 of the exchange, in response to a predetermined operation from the maintenance terminal 4, displays the traffic volume and the number of packet losses in a unit of IP telephone, which are stored in the measured result management section 36, on the screen of the monitor display of the maintenance terminal 4; and displays the traffic volume in a unit of group stored in the measured result management section 36 on the screen of the monitor display of the maintenance terminal 4.

Further, the control section 40 of the exchange, when traffic volume of a special group increases and is over a predetermined allowable volume, for example, based on the traffic volume in a unit of group stored in the measured result management section 36 or the circuit quality level corresponding to the traffic volume in a unit of group stored in the circuit quality level management section 39 of the exchange side, enlarges the allowable traffic volume of the special group by reducing a circuit traffic allowable volume of a group having a sufficient traffic volume through a channel control 32.

In addition, in the claims: the LAN network corresponds to the LAN network 5 or 5A; the LAN port corresponds to the LAN port 14A; the IP telephone corresponds to the IP telephones 2 or 2A; the traffic volume measuring means corresponds to the traffic volume measuring section 17; the circuit quality level generating means corresponds to the circuit quality level generating section 22; the display control means corresponds to the control section 40 and monitor display 13; the IP telephone exchange corresponds to the IP telephone exchange 3; the measured result notifying means corresponds to the measured result notifying section 24; the packet loss number measuring means corresponds to the packet loss number measuring section 18; the measured result receiving means corresponds to the measured result receiving section 33; the measured result summarizing means corresponds to the measured result summarizing section 35; and the display control means of the exchange side corresponds to the display control section 40 of the exchange side and maintenance terminal 4.

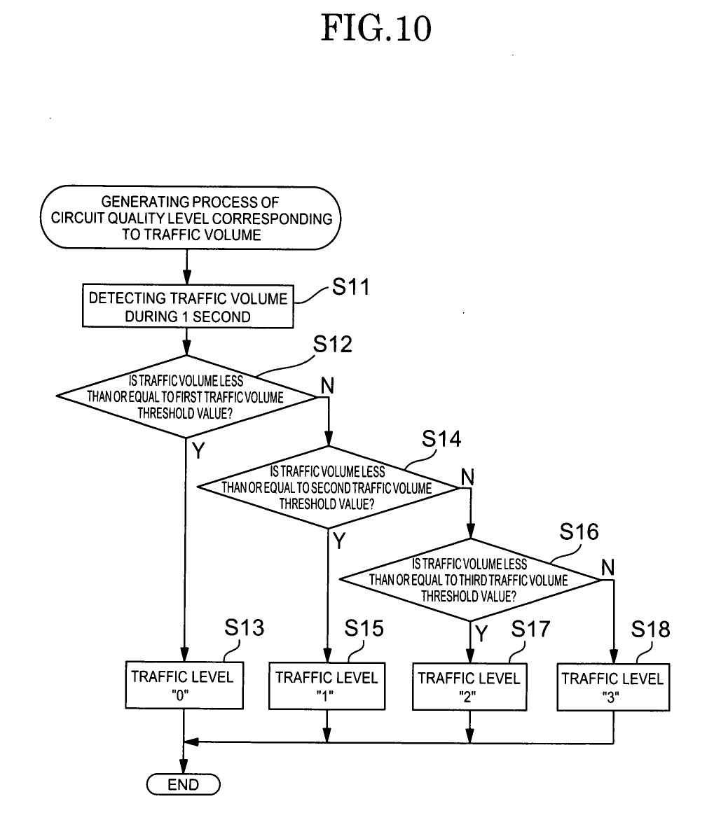

Next, the operation of the IP telephone 1 according to the present embodiment will be described. FIG. 10 is a flow chart showing processing operation of the circuit quality level generating section 22 which relates to the generating process of the circuit quality level corresponding to the traffic volume of the IP telephone relating to the present embodiment.

The generating process of the circuit quality level corresponding to the traffic volume shown in FIG. 10 is the process for always measuring the traffic volume during 1 second through the traffic volume measuring section 17, and for generating the circuit quality level corresponding to this measured result that is the traffic volume.

In FIG. 10, when the circuit quality level generating section 22 detects the traffic volume during 1 second stored in the measured result memory section 20 (step S11), determines whether this traffic volume is less than or equal to the first traffic volume threshold value (499 packets) (step 12).

When the circuit quality level generating section 22 determines that the traffic volume is less than or equal to the first traffic volume threshold value, then generates the circuit quality level of the traffic level “0” indicating an optimum circuit quality level condition as shown in FIG. 5A (step S13), stores this circuit quality level into the circuit quality level management section 23, and finishes this processing operation.

Alternatively, when the circuit quality level generating section 22 determines that the traffic volume is greater than the first traffic volume threshold value in step S12, then determines whether the same traffic volume is less than or equal to the second traffic volume threshold value (500 to 999 packets) (step 14).

When the circuit quality level generating section 22 determines that the traffic volume is less than or equal to the second traffic volume threshold value, then generates the circuit quality level of the traffic level “1” indicating good but not optimum circuit quality level condition as shown in FIG. 5A (step S15), stores this circuit quality level into the circuit quality level management section 23, and finishes this processing operation.

Alternatively, when the circuit quality level generating section 22 determines that the traffic volume is greater than the second traffic volume threshold value in step S14, then determines whether the same traffic volume is less than or equal to the third traffic volume threshold value (step 16).

When the circuit quality level generating section 22 determines that the traffic volume is less than or equal to the third traffic volume threshold value, then generates the circuit quality level of the traffic level “2” indicating a circuit quality level condition that the communication quality is deterioration but able to communicate as shown in FIG. 5A (step S17), stores this circuit quality level into the circuit quality level management section 23, and finishes this processing operation.

Alternatively, when the circuit quality level generating section 22 determines that the traffic volume is greater than the third traffic volume threshold value in step S16, then generates the circuit quality level of the traffic level “3” indicating a circuit quality condition that interferes the communications as shown in FIG. 5A (step S18), stores this circuit quality level into the circuit quality level management section 23, and finishes this processing operation.

Since the generating process of circuit quality level corresponding to the traffic volume shown in FIG. 10 always measures the traffic volume and generates the 4 stages of circuit quality level corresponding to the traffic volume based on the traffic volume during 1 second as the measured result, displays this circuit quality level on the screen of the monitor display 13. The user of this IP telephone 2 can recognize the circuit quality level corresponding to the traffic volume by visually identifying the display contents.

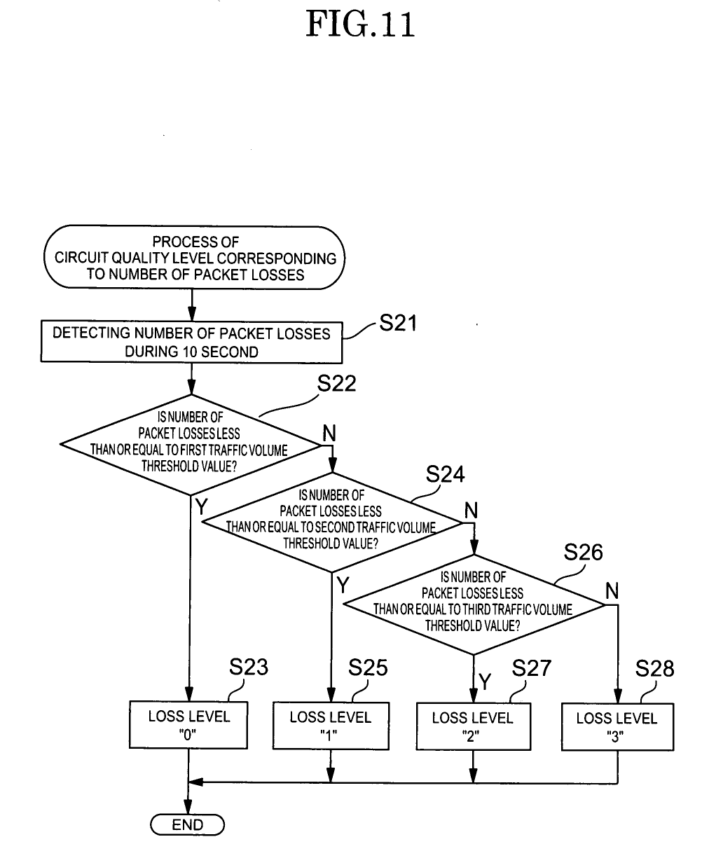

FIG. 11 is a flow chart showing processing operation of the circuit quality level generating section 22 relating to generating process of the circuit quality level corresponding to the number of packet losses of the IP telephone 2 relating to the present embodiment.

The generating process of the circuit quality level corresponding to the number of packet losses shown in FIG. 10 is the process for measuring the number of packet losses from the received packets during 10 seconds through the packet loss measuring section 18, and for generating the circuit quality level corresponding to the number of packet losses as the measured result.

In FIG. 11, when the circuit quality level generating section 22 detects the number of packet losses during 10 seconds stored in the measured result memory section 20 (step S21), then determines whether the number of packet losses is less than or equal to the first packet loss threshold value (9 packets) (step S22).

When the circuit quality level generating section 22 determines the number of packet losses is less than or equal to the first packet loss threshold value, generates the circuit quality level that is loss level “0” indicating an optimum circuit quality condition as shown in FIG. 5B (step S23), stores this circuit quality level into the circuit quality level management section 23, and finishes this processing operation.

Alternatively, when the circuit quality level generating section 22 determines the number of packet losses is greater than the first packet loss threshold value, then determines whether the number of packet losses is less than or equal to the second packet loss threshold value (10 to 49 packets) (step S24).

When the circuit quality level generating section 22 determines the number of packet losses is less than or equal to the second packet loss threshold value, generates the circuit quality level that is loss level “1” indicating a circuit quality condition that is good but not optimum as shown in FIG. 5B (step S25), stores this circuit quality level into the circuit quality level management section 23, and finishes this processing operation.

Alternatively, when the circuit quality level generating section 22 determines the number of packet losses is greater than the second packet loss threshold value, then determines whether the number of packet losses is less than or equal to the third packet loss threshold value (50 to 99 packets) (step S26).

When the circuit quality level generating section 22 determines the number of packet losses is less than or equal to the third packet loss threshold value, generates the circuit quality level that is loss level “2” indicating a circuit quality condition that communication quality is deterioration but able to communicate as shown in FIG. 5B (step S27), stores this circuit quality level into the circuit quality level management section 23, and finishes this processing operation.

Alternatively, when the circuit quality level generating section 22 determines the number of packet losses is greater than the third packet loss threshold value, generates the circuit quality level that is loss level “3” indicating a circuit quality condition that interferes the communications as shown in FIG. 5B (step S28), stores this circuit quality level into the circuit quality level management section 23, and finishes this processing operation.

Since the generating process of circuit quality level corresponding to the number of packet losses shown in FIG. 11 measures the packet losses from the received packets during 10 seconds, and generates the circuit quality level corresponding to the 4 stages of the number of packet losses based on this measured result, displays this circuit quality level on the screen of the monitor display 13. Therefore, the user of the IP telephone 2 can recognize the circuit quality level corresponding to the number of packet losses by visually checking the display contents.

Further, the circuit quality level generating section 22 measures the received packets during 1 second, and when determines that this measured result is greater than or equal to the Dos attack threshold value (2000 packets), generates the circuit quality level corresponding to the Dos attack indicating the Dos attack occurrence, and stores this circuit quality level into the circuit quality level management section 23.

In addition, the circuit quality level corresponding to the Dos attack is a concept that is a direct extension of the circuit quality level corresponding to the traffic volume, it is for this reason that the received packets, as a usage that is distinguishably managed, are in the shutout condition, then there is a difference that the received packets are not exactly counted. That is, in order to avoid occurring a phenomenon that the IP telephone 2 does not normally operate when after the Dos attack is stopped, due to unexpected congestions occurring in the IP telephone 2 for incoming packets beyond the processing ability of the IP telephone, the IP telephone 2 uses a process that abandons packets during a predetermined time after determining the Dos attack. That is, the IP telephone 2 will continue the communications if the circuit quality level corresponding to the traffic volume is indicating the worst value; while will stop the communications if it reaches the Dos attack threshold value.

Further, the measured results notification section 24 of the IP telephones 2 or 2A, via the LAN network 5 or 5A, notifies the IP telephone 3 the measured result such as traffic information and packet loss information stored in the measured result memory section 20 at predetermined timing adding the own IP telephone distinguished information thereto.

When the measured result receiving section 33 of the IP telephone exchange 3 receives the measured result of each IP telephone 2 or 2A, sequentially stores this received measured result into the measured result memory section 34 of the exchange side.

The measured result summarizing section 35, based on the measured result of each IP telephone 2 stored in the measured result memory section 34 of the exchange side, summarizes the traffic volume and number of packet losses in a unit of the IP telephone and the traffic volume in a unit of group, and stores these traffic volume and number of packet losses in a unit of the IP telephone and the traffic volume in a unit of group into the measured result management memory section 36.

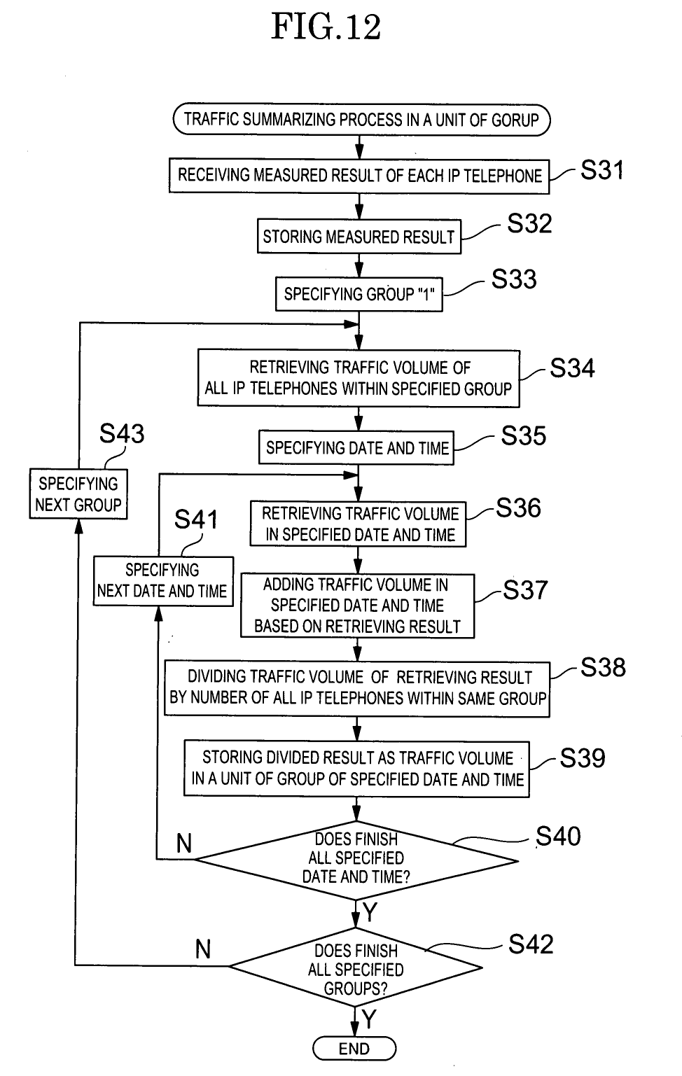

Next, the traffic summarizing process in a unit of group for summarizing traffic volume in a unit of group of the measured result summarizing section 35 will be described. FIG. 12 is a flow chart showing processing operation of the traffic summarizing process in a unit of group relating to the measured result summarizing section 35 of the IP telephone exchange 3.

The traffic summarizing process in a unit of group shown in FIG. 12 is a process for summarizing the traffic volume in a unit of group of each IP telephone 2 or 2A, based on the measured result of each IP telephone 2 stored in the measured result memory section 34 of the exchange side.

In FIG. 12, when the measured result receiving section 33 within the IP telephone exchange 3 receives the measured result of each IP telephone 2 or 2A (step S31), sequentially stores this received measured result of each IP telephones 2 or 2A into the measured result memory section 34 of the exchange side (step S32).

The measured result summarizing section 35 specifies the group “1” based on the measured result stored in the measured result memory section 34 of the exchange side (step S33), retrieves the traffic volume of all IP telephones 2 corresponding to the specified group based on the group number stored in the measured result memory section 34 of the exchange side (step S34), specifies the date and time of the summarizing target based on the retrieved result (step S35), and retrieves the traffic volume of all IP telephones 2 corresponding to the specified group and specified date and time (step S36). In addition, the traffic volume of the specified date and time corresponds to traffic volume detected within the same group at the same date and time.

When the measured result summarizing section 35 retrieves all traffic volume of the specified date and time, adds all traffic volume of the specified date and time based on the retrieved result (step S37).

When the measured result summarizing section 35 adds all traffic volume of the specified date and time, divides this traffic volume as the added result by the number of all IP telephones 2 within the same group (step S38), regards this divided result as the traffic volume of the same group and the same date and time, and stores this traffic volume in a unit of group into the measured result management memory section 36 (step S39). In addition, the measured result management memory section 36 manages the traffic volume in a unit of group at each specified date and time.

When the measured result summarizing section 35 stores the traffic volume in a unit of group into the measured result management memory section 36, determines whether finishing to specify date and time of all summarizing targets (step S40).

Unless the measured result summarizing section 35 finishes to specify date and time of all summarizing targets, specifies the date and time of the next summarizing target (step S41), and moves to step S36 in order to retrieve the traffic volume of the same specified date and time.

When the measured result summarizing section 35 finishes to specify date and time of all summarizing targets in step S40, determines whether finishing to specify group of all summarizing targets (step S42).

Unless the measured result summarizing section 35 finishes to specify group of all summarizing targets, specifies the group of the next summarizing target (step S43), and moves to step S34 in order to retrieve the traffic volume of all IP telephones 2 or 2A within the same specified group.

When the measured result summarizing section 35 finishes to specify group of all summarizing targets, determines that the summarizing the traffic volume in a unit of group all finishes, and finishes this processing operation.

In addition, as a result of this, because of storing the traffic volume in a unit of group at each specified date and time into the measured result management memory section 36, the maintenance manager of the maintenance terminal 4 side can brow the traffic volume in a unit of group of each specified date and time stored in the measured result management memory section 36 on the screen of the display, by accessing to the IP telephone exchange 3 and by according to a predetermined operation.

The traffic summarizing process in a unit of group shown in FIG. 12, based on the measured result of each IP telephone 2 or 2A stored in the measured result memory section 34 of the exchange side, adds the traffic volume of each IP telephone 2 within the same group and of the same specified date and time, divides the total traffic volume of this added result by the number of IP telephones 2 within the same group, summarizes the traffic volume of this divided result as the average traffic volume within the same group and of the same specified date and time, and sequentially stores this summarized average traffic volume in a unit of group into the measured result management memory section 36 at each specified date and time; so that the IP telephone exchange 3 can recognize the traffic volume in a unit of group of each specified date and time.

And, the circuit quality level generating section 38 of the exchange side generates the circuit quality level corresponding to the traffic volume, circuit quality level corresponding to the number of packet losses, and circuit quality level corresponding to the Dos attack, based on the traffic volume and the number of packet losses in a unit of the IP telephone stored in the measured result management memory section 36, and stores the generated circuit quality level corresponding to the traffic volume, circuit quality level corresponding to the number of packet losses, and circuit quality level corresponding to the Dos attack into the circuit quality level management section 39 of the exchange side.

In addition, though the circuit quality level generating section 38 of the exchange side generates the circuit quality level corresponding to the traffic volume, circuit quality level corresponding to the number of packet losses, and circuit quality level corresponding to the Dos attack each IP telephone 2; if the same processing operation as that of the circuit quality level generating section 23 of the IP telephone 2 performs, based on the storage contents of the measured result management memory section 36 and the threshold value management table 37 of the exchange side, it will generate the circuit quality level corresponding to the traffic volume, circuit quality level corresponding to the number of packet losses, and circuit quality level corresponding to the Dos attack in a unit of IP telephone 2.

And, the circuit quality level generating section 38 of the exchange side generates the circuit quality level corresponding to the traffic volume in a unit of group based on the traffic volume in a unit of group stored in the measured result management memory section 36 and the traffic volume threshold value stored in the threshold value management table 37 of the exchange side. For example, it generates the circuit quality level corresponding to the traffic volume as follows: traffic level “0” when the traffic volume is less than or equal to the first traffic volume threshold value (499 packets); traffic level “1” when the traffic volume is less than or equal to the second traffic volume threshold value (500 to 999 packets); traffic level “2” when the traffic volume is less than or equal to the third traffic volume threshold value (1000 to 1499 packets); or traffic level “3” when the traffic volume is greater than the third traffic volume threshold value.

The circuit quality level generating section 38 of the exchange side generates the circuit quality level corresponding to the traffic volume, circuit quality level corresponding to the number of packet losses, and circuit quality level corresponding to the Dos attack in a unit of IP telephone 2 and stores these circuit quality levels in a unit of IP telephone into the circuit quality level management section 39 of the exchange side; it also generates the circuit quality level corresponding to the traffic volume in a unit of group and stores this circuit quality level corresponding to the traffic volume in a unit of group into the circuit quality level management section 39 of the exchange side.

The control section 40 of the exchange side, in response to a predetermined operation from the maintenance terminal 4, provides the circuit quality level corresponding to the traffic volume, circuit quality level corresponding to the number of packet losses, and circuit quality level corresponding to the Dos attack in a unit of IP telephone 2, further the circuit quality level corresponding to the traffic volume in a unit of group stored in the circuit quality level management section 39 of the exchange on the display screen of the maintenance terminal 4.

According to the present embodiment, because of always measuring the traffic volume of the packets through the LAN port 14A, generating the circuit quality level corresponding to the traffic volume based on this measured result of the traffic volume, and displaying this generated circuit quality level corresponding to the traffic volume on the screen of the monitor display 13 of the IP telephones 2 or 2A; then the user of each IP telephone 2 or 2A can grasp the circuit quality level corresponding to the traffic volume on the LAN network 5 in real time under condition except when during communications as well as during communications. As a result, by grasping the deterioration of the circuit quality level of the communications involved in increasing the traffic volume, the user can distinguish the deterioration of the communications quality is whether by depending upon the network or by failure of the equipment, so that it is able to shorten the spending time from the trouble occurring to the improvement of the communications quality.

Further, according to the present embodiment, because of notifying the measured result of the traffic volume measuring section 17 of each IP telephone 2 or 2A to the IP telephone exchange 3 by which this IP telephone 2 or 2A is accommodated for connection, the IP telephone exchange 3 can intensively grasp the traffic volume under condition except when during communications as well as during communications.

Further, according to the present embodiment, because of measuring the number of packet losses through the LAN port 14A, generating the circuit quality level corresponding to the number of packet losses based on this measured result of the number of packet losses, and displaying this generated circuit quality level corresponding to the number of packet losses on the monitor display 13 of the IP telephone 2 or 2A; then the user of each IP telephone 2 or 2A can certainly grasp the circuit quality level corresponding to the number of packet losses in real time, as well as grasp the circuit quality level corresponding to the traffic volume. As a result, by grasping the deterioration of the circuit quality level of the communications involved in increasing the number of packet losses, it is able to shorten the spending time from the trouble occurring to the improvement of the communications quality.

Further, according to the present embodiment, because of notifying the measured result of the number of packet losses measuring section 18 of each IP telephone 2 or 2A to the IP telephone exchange 3 by which this IP telephones 2 or 2A is accommodated for connection, the IP telephone exchange 3 can intensively grasp the number of packet losses of each IP telephone 2 as well as the traffic volume of each IP telephone 2 or 2A.

Further, according to the present embodiment, because of measuring the number of received packets (traffic volume) through the LAN port 14A, and displaying the circuit quality level corresponding to the Dos attack indicating the Dos attack occurring when determining this number of received packets (traffic volume) is greater than or equal to the Dos attack threshold value (2000 packets), user can grasp the Dos attack occurring of each IP telephone 2 or 2A.

According to the present embodiment, the IP telephone exchange 3 receives the measured result of each IP telephone 2 or 2A, summarizes this received measured result of each IP telephone 2 or 2A, and displays the summarized measured result of each IP telephone 2 on the display screen of the maintenance terminal 4, so that the maintenance person of the maintenance terminal 4, who manages the LAN network 5 of the IP telephone exchange 3, can intensively grasp the traffic volume and number of packet losses by visually checking the screen display contents without checking the monitor screen contents of each IP telephone 2 or 2A respectively, and can specify the cause of trouble. As a result, it is able to shorten the spending time from the trouble occurring to the improvement of the communications quality.

Further, according to the present embodiment, based on the traffic volume in a unit of group stored in the measured result management memory section 36 of the IP telephone exchange 3 or the circuit quality level corresponding to the traffic volume in a unit of group stored in the circuit quality level management section 39 of the exchange, when the traffic volume of the specific group increases beyond a predetermined allowable volume, for example, because of reducing the circuit allowable traffic volume of a group having a margin of traffic volume via the communications channel control section 32, and enlarging the allowable traffic volume of the specific group, it is able to gain efficiency of the circuit source on the LAN network 5.

In addition, the above present embodiment displays the circuit quality level corresponding to the traffic volume, circuit quality level corresponding to the number of packet losses, and circuit quality level corresponding to the Dos attack stored in the circuit quality level management section 23 each level (traffic level and loss level) on the screen of the monitor display 13 of the IP telephone 2 or 2A in real time; however, not in real time, for example, it may only display the worst level during 3 minutes of each circuit quality level stored in the circuit quality level management section 23 on the screen of the monitor display 13. For example, even if detecting that the current traffic level of the circuit quality level is “0”, when already detecting that the traffic level is “2” in past 1 minute within 3 minutes, then it will not display the circuit quality level “0”, but it may display the circuit quality level that is the worst level “2” within the 3 minutes. In this case, it would be able to recognize the worst level of the circuit quality level within 5 minutes.

Further, the above present embodiment notifies the measured result stored in the measured result memory section 20 of each IP telephone 2 or 2A to the IP telephone exchange 3 each 10 minutes; for example, it notifies the number of 600 traffic volume corresponding to those of 10 minutes as the measured result to the IP telephone exchange 3; however, for example, by averaging the number of 60 traffic volume corresponding to those of 1 minute, it may notify the 10 average traffic volume corresponding to 10 minutes as the measured result to the IP telephone exchange 3. In this case, it is able to make the data volume to the IP telephone exchange 3 compact. As a result, it is able to significantly gain efficiency of the date transmitting the measured result.

### USEFUL POSSIBILITY IN INDUSTRIES

The IP telephone according to the present invention always measures the traffic volume of packets though the LAN port, generates the circuit quality level corresponding to the traffic volume based on this measured result, and displays the generated circuit quality level corresponding to the traffic volume on the screen display; so that the user can grasp the circuit quality level corresponding to the traffic volume on the network under condition except when during communications as well as during communications in real time. As a result, the user can grasp the deterioration of the communications quality involved in increasing the number of packet losses, and distinguish the deterioration of the communications quality is whether by depending upon the network or by failure of the equipment, so that it is able to shorten the spending time from the trouble occurring to the improvement of the communications quality.

1. An IP telephone having a LAN port for connecting to a LAN network, and for transmitting and receiving packets through the LAN port, the IP telephone comprising:
traffic volume measuring means for always measuring the traffic volume of packets through the LAN port;
circuit quality level generating means for generating the circuit quality level corresponding to the traffic volume based on the measured result of the traffic volume measured by the traffic volume measuring means; and
display control means for displaying the circuit quality level corresponding to the traffic volume generated by the circuit quality level generating means.

2. The IP telephone according to claim 1, further comprising measured result notifying means for notifying the measured result of the traffic volume measuring means to an IP telephone exchange by which the IP telephone is accommodated for connection.

3. The IP telephone according to claim 1, further comprising packet loss measuring means for measuring the number of packet losses through the LAN port, wherein the circuit quality level generating means generates the circuit quality level corresponding to the number of packet losses based on the measured result of the number of packet losses measured by the packet loss measuring means, and displays this generated circuit quality level corresponding to the number of packet losses through the display control means.

4. The IP telephone according to claim 3, further comprising measured result notifying means for notifying the measured result of the packet loss measuring means to the IP telephone exchange by which the IP telephone is accommodated for connection.

5. The IP telephone according to claim 2, wherein the IP telephone exchange comprising:
measured result receiving means for receiving the measured result of the traffic volume measuring means through the measured result notifying means of each IP telephone accommodated for connection;
measured result summarizing means for summarizing the measured result of each IP telephone received by this measured result receiving means; and
display control means of the exchange side for displaying the measured result of each IP telephone summarized by this measured result summarizing means.

6. The IP telephone according to claim 5, wherein the IP telephone exchange manages each IP telephone accommodated for connection in a unit of group, summarizes the measured result of each IP telephone in a unit of group through the measured result summarizing means, and displays the measured result summarized by this measured result summarizing means in a unit of group through the display control means of the exchange side.

7. The IP telephone according to claim 4, wherein the IP telephone exchange comprising:
measured result receiving means for receiving the measured result of the packet loss measuring means through the measured result notifying means of each IP telephone accommodated for connection;
measured result summarizing means for summarizing the measured result of each IP telephone received by this measured result receiving means; and
display control means of the exchange side for displaying the measured result of each IP telephone summarized by this measured result summarizing means.

8. The IP telephone according to claim 2, further comprising packet loss measuring means for measuring the number of packet losses through the LAN port, wherein the circuit quality level generating means generates the circuit quality level corresponding to the number of packet losses based on the measured result of the number of packet losses measured by the packet loss measuring means, and displays this generated circuit quality level corresponding to the number of packet losses through the display control means.

9. The IP telephone according to claim 5, wherein the IP telephone exchange comprising:
measured result receiving means for receiving the measured result of the packet loss measuring means through the measured result notifying means of each IP telephone accommodated for connection;
measured result summarizing means for summarizing the measured result of each IP telephone received by this measured result receiving means; and
display control means of the exchange side for displaying the measured result of each IP telephone summarized by this measured result summarizing means.

10. The IP telephone according to claim 6, wherein the IP telephone exchange comprising:
measured result receiving means for receiving the measured result of the packet loss measuring means through the measured result notifying means of each IP telephone accommodated for connection;
measured result summarizing means for summarizing the measured result of each IP telephone received by this measured result receiving means; and
display control means of the exchange side for displaying the measured result of each IP telephone summarized by this measured result summarizing means.
